(19) United States
(12) Patent Application Publication
(10) Pub. No.: US 2018/0083482 A1
(43) Pub. Date: Mar. 22, 2018

(54) SUPPLY-DEMAND BALANCING METHOD AND SYSTEM FOR POWER MANAGEMENT IN SMART GRID

(71) Applicant: Nestfield Co., Ltd., Ansan-si (KR)

(72) Inventors: Seung Ho HONG, Seoul (KR); Mengmeng YU, Ansan-si (KR)

(73) Assignee: Nestfield Co., Ltd., Ansan-si (KR)

(21) Appl. No.: 15/432,524

(22) Filed: Feb. 14, 2017

(30) Foreign Application Priority Data
Sep. 19, 2016 (KR) 10-2016-0119384

(51) Int. Cl. H02J 13/00; G05B 13/02

(52) U.S. Cl. CPC H02J 13/0006; G05B 13/026

(57) ABSTRACT

A Stackelberg game approach is used to describe a Demand-Response (DR) model for electricity trading between one utility company and multiple users, balancing supply and demand as well as smoothing an aggregated load in the power grid system. The interactions between the utility company and users are formulated into a 1-leader and N-follower Stackelberg game, where optimization problems are formed for each player to help select an optimal strategy. A pricing function is adopted for regulating real-time prices (RTP), and acts as a coordinator inducing users to join the game. An iterative algorithm is proposed to derive a Stackelberg equilibrium, through which optimal power generation and power demands are determined for the utility company and users, respectively.

### CROSS-REFERENCE TO RELATED APPLICATIONS

This application is based upon and claims the benefit of priority from the prior Korean Patent Application No. 10-2016-0119384, filed on Sep. 19, 2016, with the Korean Intellectual Property Office, the disclosure of which is incorporated herein in its entirety by reference.

### STATEMENT REGARDING PRIOR DISCLOSURES BY THE INVENTOR OR A JOINT INVENTOR

Applicant hereby states under 37 CFR 1.77(b)(6) that Mengmeng Yu and Seung Ho Hong, Supply-demand balancing for power management in smart grid: A Stackelberg game approach, Applied Energy 164, published on Feb. 15, 2016, is designated as a grace period inventor disclosure. The disclosure: (1) was made one year or less before the effective filing date of the claimed invention; (2) names the inventor or a joint inventor as an author; and (3) does not name additional persons as authors on a printed publication.

### TECHNICAL FIELD

The present disclosure relates to a supply-demand balancing method and a system thereof for power management in a smart grid.

### BACKGROUND

Conventional power grids are confronting the challenges of increased demand, and grid stability and environmental pollution. Smart grids are envisioned as novel power-grid systems incorporating a smart metering infrastructure capable of sensing and measuring the power consumption of users, along with demand-response (DR) programs that promise solutions for enhancing the efficiency of future power girds. A DR program considers energy usage changes of users in response to varying electricity prices or incentive payments with the aim of balancing supply and demand of power, reducing power generation costs through alleviation of the peak load, and shifting demand from on-peak to off-peak times. As a result, the DR program achieves better utilization of generated power and brings economic benefits for both the utility supplier and users. Using a DR program, it becomes possible for the utility supplier to motivate users to jointly flatten the demand curve and match supply to demand, thereby ensuring the stability of the grid.

Given the interoperation parameters among different entities in the DR program, game theory provides a naturally suitable framework for modeling interactions among different participators with various objectives. Recently, Stackelberg games, which are used to study hierarchical decision-making processes of multiple decision makers, have attracted attention in the design of energy management schemes. The Stackelberg games have been used to model electricity trading between the retailer and customers, with the aim of minimizing the customer's daily payments while maximizing the retailer's profit by optimizing electricity prices. Chen et al. in an article entitled “An innovative RTP-based residential power scheduling scheme for smart grids,” (presented at the Acoustics, Speech and Signal Processing (ICASSP), IEEE International Conference on 2011) proposed a Stackelberg game-based power scheduling scheme between a service provider and residential consumers with similar objectives. An inconvenience cost incurred by delaying loads to a cheaper price period is also considered, alongside a minimization of electricity bills. A bi-level programming technique has been used to design a Stackelberg game for modeling the demand response in electricity retail markets with the aim of reducing the comfort losses of consumers as well as the costs of purchasing electricity in the lower sub-problems, which is subject to the retailer's upper sub-problem of, for example, reducing imbalances caused by deviations in wind power production from day-ahead forecasts. Kilkki et al. in an article entitled “Optimized control of price-based demand response with electric storage space heating,” (published in Indust Inf, IEEE Trans 2015) proposed a Stackelberg game scenario for electricity markets, wherein the retailer is taken as the main perspective, with the goal of profit maximization. A simulation framework was designed involving customers' uncertainties of electricity storage space heating loads, upon which partial imbalance could be eliminated by offering additional discounts to customers. Maharjan et al. in an article entitled “Dependable demand response management in the smart grid: a Stackelberg game approach,” (published in Smart Grid, IEEE Trans 2013) presented a Stackelberg game framework involving multiple utilities and consumers aimed at maximizing each game player's revenue.

### SUMMARY

One of the objects of the present disclosure is to solve the problems in the conventional methods and systems, providing a novel demand-response model between one utility company and multiple users. Unlike previous technologies, which dealt solely with profit maximization for the utility company and cost minimization for the user, the present disclosure balances supply and demand as well as flattens the aggregated loads in the system while guaranteeing the profit of the utility company and cost minimization for the user through carefully defining the objective function at each side.

Another object of the present disclosure is to provide a price-based DR model that models the electricity trading process between the utility company and users while balancing the supply and demand as well as smooting the aggregated load in the system.

Yet, another object of the present disclosure is to formulate the interactions between the utility company and users into a 1-leader and N-follower Stackelberg game, where a pricing function is adopted for regulating real-time prices (RTP) and acts as a coordinator to induce users to join the proposed game.

Yet, another object of the present disclosure is to propose an iterative algorithm between the utility company and users to derive the Stackelberg equilibrium, through which the optimal power generation and demands are determined for the utility company and users, respectively.

### BRIEF DESCRIPTION OF DRAWINGS

FIG. 1 is a view illustrating a block diagram (a system model) of a supply-demand balance system for electric power demand management of a smart grid, according to the present disclosure;

FIG. 2 is a view illustrating a signal flow between a utility company and multiple users in the supply-demand balance system for electric power demand management of the smart grid, according to the present disclosure;

FIG. 3 is a flowchart illustrating the interactive process between utility company and users in a supply-demand balance method for electric power demand management of the smart grid, according to the present disclosure;

FIG. 4 is a graph illustrating real-time prices in cases with and without a limited condition represented as an equation (e.g., an equation represented as equation (8c) below);

FIGS. 5(a), 5(b), and 5(c) are graphs each illustrating the optimal electric power demands of three users (e.g., users 1, 2, 3) under the real-time prices;

FIG. 6 is a graph illustrating the electric power supply and an aggregated demand in a case without limited condition represented as an equation (e.g., an equation represented as equation (8c) below);

FIG. 7 is a graph illustrating the electric power supply and an aggregated demand in a case with limited condition represented as an equation (e.g., an equation represented as equation (8c) below);

FIG. 8 is a view illustrating the number of iterations according to the number of users; and

FIG. 9 is a graph illustrating the electric power supply and an aggregated demand in a case where the number of users is 200.

### DESCRIPTION OF EMBODIMENTS

In general, the players in a game, together with their strategies and utility functions, differ from each other according to the specific system model. Most DR models presented so far aim to maximize the profit of a utility/retailer/service provider without considering load fluctuations in the power system. However, in practice, it is also important to flatten loads in the system in order to avoid building expensive backup generators to compensate for the peak load, and a reduced peak load is advantageous for maintaining the stability of the power grid.

Hereinafter, an exemplary embodiment of a supply-demand balance system and a method thereof for electric power demand management in a smart grid according to the present disclosure will be described in detail with reference to accompanying drawings.

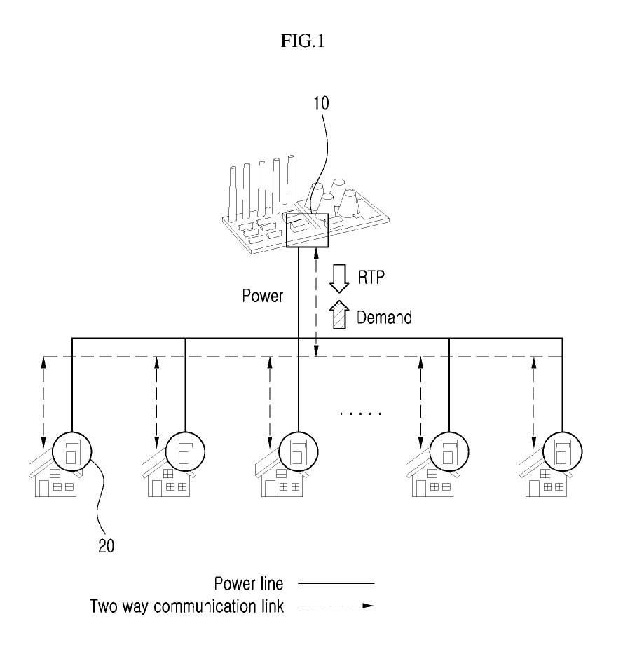

FIG. 1 is a view illustrating a block diagram (a system model) of a supply-demand balance system for electric power demand management in a smart grid, according to the present disclosure. In particular, FIG. 1 illustrates a system model with advanced metering infrastructures that enables a two-way communication between one utility company and a set of multiple users (e.g. N users).

In FIG. 1, the utility company is an electric power manufacturer supplying the electric power to the users, and equipped with a power management apparatus 10. A user is a consumer of the electric power purchasing and consuming the electric power, and includes power metering devices 20 such as smart meters.

In reality, the power management apparatus 10 is connected to the multiple power metering devices 20 via power lines and data communication lines to be interactive with each other. However, for the convenience of description, it is assumed that the interaction occurs between the utility company and the users.

### Utility Company Model

Assuming that Cₜ(gₜ) is the cost function for the utility company generating a quantity of power gₜ during slot t(t∈T, T=|T|), which is a monotonically increasing function of the generation quantity and is strictly convex, the most commonly used cost function is as follows:

$${C}_{t} ( {g}_{t} ) = \frac{{a}_{t}}{2} {g}_{t}^{2} + {b}_{t} {g}_{t} + {C}_{t} \qquad ( 1 )$$

where aₜ, bₜ and cₜ are the predetermined generation coefficients which may vary between different time slots of the day.

When the marginal cost is defined as the change in the cost when the produced quantity changes by one unit, the marginal cost function can be defined as follows:

C′ₜ(gₜ)=aₜgₜ+bₜ (2)

With the price-based DR programs according to the present disclosure, the utility company is responsible for regulating real-time prices to induce users to participate in the DR program, such that the utility company and users can jointly help calculating the quantity of generated power as well as the demand, so as to reduce the difference between the supply and demand of powers.

In order to guarantee the profit for the utility company, it is clear that real-time prices used to bill users should not be lower than the marginal cost. An efficient pricing function has been proposed, whereby the utility company regulates the price pₜ(gₜ) for slot t by multiplying a time-dependent profit coefficient λₜ (λₜ≧1) with the marginal cost, i.e.,

pₜ(gₜ)=λₜC′ₜ(gₜ)=λₜ(aₜgₜ+bₜ)λₜ≧1 (3)

The effectiveness of the pricing function as represented in equation (3) described above has been validated, and coordinates the interactions between the utility company and users, and helps to minimize the generation cost of the utility company.

According to equation (3) above, the daily prices can be expressed as p(g)=[p₁(g₁), p₂(g₂), . . . , p_{T}(g_{T})] or [pₜ(gₜ)]ₜ₌₁^{T}, where g=[g₁, g₂, . . . , g_{T}] denotes the power generation vector across a day. These prices are then used to encourage users to shift demand to off-peak times.

From the utility company's perspective, besides considering a reduction in the generation cost, it is also desirable to smooth the hourly generation, so as to avoid building expensive backup generators to compensate for the peak load. A reduced peak load is thus beneficial for maintaining the stability of the power grid. Accordingly, it is assumed that the objective of the utility company is to determine the optimal power generation vector through minimizing variations in generation, while meeting the requirements of the user, through which supply and demand can be matched. To this end, the optimization problem is formulated as follows:

$$\begin{matrix}{min}_{{g}_{t}} {U}_{UC} ( g ) = {\sum }_{t ∈ T}^{ } {( {g}_{t} - \overline{g} )}^{2} & ( 4 a ) \\ s . t . {L}_{t} \leq {g}_{t} \leq min ( {g}_{t}^{+} , {L}_{t}^{max} ) & ( 4 b )\end{matrix}$$

where U_{UC} denotes the utility function of the utility company, g̅ represents the average power generation during the day; i.e., g̅=Σ_{t∈T}·gₜ/T, and Lt is the sum of power demands of all users at slot t, i.e., Lₜ=Σ_{n∈N} l_{n,t}, and l_{n,t} denotes the demand of user n during slot t. It is noted that the relationship (4b) regulates gₜ such that it will always be equal to or greater than Lₜ. The primary reason for adopting this constraint regarding gₜ is to guarantee that generation can meet users' requirements at all times. Lₜ^{max} denotes the maximum power demand of all users at slot t, and g⁺ₜ is the maximum generation capacity of the utility company during slot t.

It is noted that the objective in equation (4a) differs from the profit maximization equation. However, the proposed model indirectly accounts for the profit because the pricing function in equation (3) has been validated to guarantee low generation costs. To some extent, reducing costs is equivalent to increasing profits. Moreover, the objective defined in equation (4a) described above brings additional advantages besides smoothing the hourly generation (or minimizing the generation variance). In power systems, the load factor (LF) is utilized as a measure of efficiency for electrical energy usage, which is defined as the ratio of the average energy demand to the maximum demand during a period. A greater value of LF indicates higher energy usage efficiency. It also has been proven that minimizing the variance of the generation in equation (4a) is practically equivalent to maximizing the load factor, which is defined as follows:

$$LF = \frac{{L}_{avg}}{{L}_{max}} \qquad ( 5 )$$

where L_{avg}=Σ_{t∈T} Lₜ/T denotes the average load in the system, and Lₘₐₓ=max Lₜ(∀t∈T) represents the maximum load during a single slot.

### User Model

The utility function for each user n is defined as:

$${U}_{n} ( {l}_{n} ) = {\sum }_{t ∈ T}^{ } {ϕ}_{n , t} ( {l}_{n , t} ) - {\sum }_{t ∈ T}^{ } {p}_{t} ( {g}_{t} ) \cdot {l}_{n , t} \qquad ( 6 )$$

where lₙ=[l_{n,1}, l_{n,2}, . . . , l_{n,T}] represents the power demand vector of user n, and pₜ(gₜ)·l_{n,t} represents the payment of user n for consuming power l_{n,t} during slot t, where pₜ(gₜ) (∀t∈T) are received from the utility company. φ_{n,t}(l_{n,t}) denotes the satisfaction gain of user n as a function of its consumed power l_{n,t} at slot t.

Without losing generality, φ_{n,t}(l_{n,t}) adopts the quadratic function form defined as follows:

$${ϕ}_{n , t} ( {l}_{n , t} ) = {ω}_{n , t} {l}_{n , t} - \frac{{θ}_{n}}{2} {l}_{n , t}^{2} , \\ {ω}_{n , t} > 0 \\ {θ}_{n} > 0 \qquad ( 7 )$$

where ω_{n,t} is a user preference parameter characterizing user types, which varies between users and may also vary along different time slots, and θₙ is a predetermined constant. As indicated by (7), a user with a greater ω_{n,t} prefers to consume more l_{n,t} in order to improve his/her satisfaction level.

Each user should obtain its optimal power demand vector by maximizing its utility function as follows:

$$\begin{matrix}max {U}_{n} ( {l}_{n} ) = {\sum }_{t ∈ T}^{ } {ϕ}_{n , t} ( {l}_{n , t} ) - {\sum }_{t ∈ T}^{ } {p}_{t} ( {g}_{t} ) \cdot {l}_{n , t} & ( 8 a ) \\ s . t . {l}_{n , t}^{-} \leq {l}_{n , t} \leq {l}_{n , t}^{+} & ( 8 b )\end{matrix}$$

where l_{n,t}⁻ (l_{n,t}⁺) represents the minimum (maximum) power demand of user n at slot t. In addition, a user may not wish to reduce daily power consumption but may be willing to shift the consumption from peak to off-peak time. Thus, a temporally-coupled constraint represented as equation (8c) can be included to couple the power consumption across the time horizon so as to constrain the cumulative consumption at a user designated value (e.g., daily target power consumption, denoted as Lₙ).

$${\sum }_{t ∈ T}^{ } {l}_{n , t} = {L}_{n} \qquad ( 8 c )$$

### Problem Formulation Between Utility Company and Users

In a realistic power system, it is expected that power generation always matches demand, and smart metering and two-way communications enable the supply and demand sides to interact by exchanging price and demand information. For instance, the price vector announced by the utility company will affect how the users determine their optimal power demands. In contrast, the adjusted power demands of the users will inversely impact on the utility company's generation plan, as the utility company would like to adjust generation in order to balance the demand and supply, which thus pushes the utility company to regulate the new price vector. As a consequence, due to the new price vector, the adjusted power demands of a user will inherently affect how other users determine their power demands. Thus, these factors naturally lead to interactions between the utility company and users.

The Stackelberg game is suitable means to illustrate the concept behind the system model and method of the present disclosure, where the utility company acts as the leader announcing prices to the followers (e.g., N users). Given those prices, users will react by playing a non-cooperative game, as each user's decision will inherently affect how other users make decisions. The formal definition of the 1-leader and N-follower Stackelberg game may be represented as follows:

ξ= [symbol] UtilityCompany∪N,{Ω_{UC}},{Ωₙ}_{n∈N}, U_{UC},Uₙ [symbol] (9)

Player Set UtilityCompany ∪N:

The utility company acts as the leader and the users in set N take the roles of followers in response to the utility company's strategy.

Strategy Set Ω_{UC} and Ωₙ:

Ω_{UC}={g|g∈R^{T}, Lₜ≦gₜ≦min (gₜ⁺, Lₜ^{max})} denotes the feasible strategy set of the utility company referring to equation (4b), from which the utility company chooses its strategy g which represents the daily power generation vector. And each user will select its strategy lₙ representing daily power demands from its feasible strategy set Ωₙ={lₙ|lₙ∈R^{T}, l_{n,t}⁻≦l_{n,t}≦l_{n,t}⁺}, which is defined based on equation (8b).

Utility Functions U_{UC} and Uₙ:

The utility function evaluates the selected strategy of a player in the game. The symbol U_{UC} denotes the utility function of the utility company which is defined in equation (4a), and equation (6) defines the utility function of each user n (i.e., Uₙ).

The desired outcome of a given hierarchical decision-making game takes the form of the Stackelberg equilibrium (SE). The definition of a Stackelberg equilibrium strategy (SES) together with an SE for a two-person game is given as follows.

Definition 1:

In a two-person finite game with player 1 as the leader (player 2 as the follower), a strategy s*₁∈S₁ is called a Stackelberg equilibrium strategy (SES) for the leader, if

$${max}_{{s}_{2} ∈ {R}_{2} ( {s}_{1}^{*} )} {u}_{1} ( {s}_{1}^{*} , {s}_{2} ) = {min}_{{s}_{1} ∈ {S}_{1}} {max}_{{s}_{2} ∈ {R}_{2} ( {s}_{1} )} {u}_{1} ( {s}_{1} , {s}_{2} ) = {u}_{1}^{*} \qquad ( A . 1 )$$

where uᵢ is the utility function of player i, Sᵢ is the strategy set of player i, R₂(s₁) represents the best response set of player 2 to the strategy s₁∈S₁ of player 1 defined as follows:

$${R}_{2} ( {s}_{1} ) = \{ {s}_{2}^{′} ∈ {S}_{2} : {s}_{2}^{′} = arg {max}_{{s}_{2} ∈ {S}_{2}} {u}_{2} ( {s}_{1} , {s}_{2} ) \} \qquad ( A . 2 )$$

The quantity u*₁ (A. 1) is the Stackelberg utility for the leader, which admits a unique value in the given hierarchical decision-making game referring to Theorem 3.9 in an article by Han Z et al, entitled “Game theory in wireless and communication networs,” Cambridge University Press (2001). Moreover, the SES s*₁ in (A. 1) ensures that the leader does not receive a utility that is lower than μ*₁, which thus constitutes a secured untility level for the leader. Accordingly, the Stackelberg equilibrium is defined as follows.

Definition 2:

Let s*₁∈S₁ be an SES for the leader (i.e., player 1). Then, for any strategy s*₂∈R₂(s*₁) that is in equilibrium with s*₁ satisfying (A. 1) is an optimal strategy for the follower of player 2. Thus, the pair ((s*₁, s*₂) is a Stackelberg equilibrium for the two-person game. See, also, the article by Han Z et al. entitled “Game theory in wireless and communication networs,” Cambridge University Press (2001).

As an extension, the SE of a 1-leader and N-follower game corresponds to the status at which the leader maximizes its utility given the reaction set of the followers while the followers respond to the leader's announced strategy by playing according to a specific equilibrium concept. An SES for the leader (utility company) in the game ξ should satisfy the following equation (10).

$${max}_{L ∈ {R}_{N} ( {g}^{*} )} {U}_{UC} ( {g}^{*} , L ) = {min}_{g ∈ {Ω}_{UC}} {max}_{L ∈ {R}_{N} ( g )} {U}_{UC} ( g , L ) = {U}_{UC}^{*} \qquad ( 10 )$$

where L=[l₁, l₂, . . ., l_{N}] represents the strategy profile of all the users, and R_{N}(g) denotes the best response set of N users to the strategy g∈Ω_{UC} of utility company. The symbol R_{N}(g) is included in the joint strategy sets of all the users, i.e., R_{N}(g)⊂Ω₁×Ω₂, . . . , Ω_{N}. The latter two terms in equation (10) imply that, depending on the status of SE, the utility company minimizes the variation in the generated power in response to the set of all the users, wherein the reaction set contains all the users' optimal power demand vectors as responses to the utility company's strategic choices.

Furthermore, if the quantity U*_{UC} in equation (10) admits a unique value, it means the utility company will not accept a utility value that is higher than U*_{UC}, which thus constitutes a secured utility level for the utility company.

Accordingly, the SE for the proposed game can be defined as a strategy profile (g*, L*), where g* is an SES for the utility company satisfying equation (10), and L*└R_{N}(g*) denotes the strategy profile that is in equilibrium with g* and provides optimal strategies for all the users.

In conventional game theory, a player's utility is a function of both players' strategies (e.g., in a two-person game). Accordingly, hereinafter, U_{UC} and uₙ are written as a function of both the utility company's and users' strategies because the decision made by either side will affect how the other side chooses the strategy, as described above. However, it should be noted that even Un is written in the form Uₙ(g, lₙ, l₋ₙ) (where l₋ₙ denotes all other N−1 users' strategies except user n), uₙ is not directly affected by the utility company's strategy g or l₋ₙ, but directly related to the utility company's price vector p(g) (i.e., a function of the utility company's strategy g as indicated in equation (3)), which actually acts as the coordinator between the utility company and users. Moreover, as described above, the strategy chosen by user n will also affect how the other N−1 users choose their strategies, due to the inherence among the users. For consistency, the Uₙ(g, lₙ, l₋ₙ) form is applied and it is assumed that Uₙ(g, lₙ, l₋ₙ) is affected by the utility company's strategy g and all other N−1 users' strategies l₋ₙ.

### Existence of Stackelberg Equilibrium

As described above, when provided with the utility company's prices, users will play a non-cooperative game in reaction to these prices. It has been shown that a unique NE exists in a strictly concave N-player game. In the following, descriptions will be made on the fact that a non-cooperative game among users is equivalent to a strictly concave N-player game.

First, by observing equation (6), it is straightforward that uₙ is continuous and differentiable in Ωₙ such that uₙ can be found analytically. Taking user n as an example, when receiving the price vector p(g) from the utility company, the best-response function can be obtained by taking the first derivative of uₙ with respect to l_{n,t}; i.e.,

$$\frac{\partial {U}_{n}}{\partial {l}_{n , t}} = {ω}_{n , t} - {θ}_{n} {l}_{n , t} - {p}_{t} ( {g}_{t} ) \qquad ( 11 )$$

By setting equation (11) to zero, the best-response function is obtained as follows:

$${l}_{n , t} ( {p}_{t} ( {g}_{t} ) ) = \frac{{ω}_{n , t} - {p}_{t} ( {g}_{t} )}{{θ}_{n}} \qquad ( 12 )$$

Furthermore, if the Hessian matrix H(Uₙ) is definite negative, then uₙ is strictly concave. By taking the second derivative of Un with respect to lₙ, H(Uₙ) may be obtained as follows

$$\frac{{\partial }^{2} {U}_{n}}{\partial {l}_{n , t} \partial {l}_{n , s}} = \{ \begin{matrix}- {θ}_{n} & when t = s \\ 0 & when t \neq s\end{matrix} \qquad ( 13 )$$

where s denotes any slot in the time horizon T.

From equation (13), it may be observed that all the diagonal elements of H(Uₙ) are negative due to equation (7), and the off-diagonal elements are zero. Therefore, H(Uₙ) is negative definite.

Second, it may be observed that the user strategy set Ωₙ (∀n∈N) is convex, closed and bounded, since the set Ωₙ is already defined as a convex constraint as described above.

From the above, it may be concluded that a non-cooperative game among users is equivalent to a strictly concave N-player game and it follows that, a unique Nash equilibrium (NE) exists among N users.

As described above, each time the utility company's strategy is revealed, there exists a unique NE among users, which provides the best response strategy profile for users. In the presence of such a strategy profile, the utility company will adjust its strategy in order to minimize equation (4a). It is noted that if the users' group response (i.e., the NE) to the utility company's announced strategy is not unique, then it will result in an ambiguity for the utility company when choosing its strategy, which forms the basis of an analysis of the existence of the SE.

In the presence of the strategy profile containing the best response strategies of all the users, the utility company chooses a strategy g∈Ω_{UC} aiming to minimize equation (4a), where the result of equation (4a) (i.e., the variation in the generated power) either decreases or remains unchanged each time a new strategy is selected. Moreover, it is noted the utility company's utility value in the form of equation (4a) has a lower bound since the minimum “variance” is zero. Therefore, there exists a secured utility value U*_{UC} for the utility company, which satisfies equation (10). In view of the definition of the SE as described above, it may be concluded that an SE exists for the proposed 1-leader and N-follower Stackelberg game.

### Iterative DR Algorithm for SE

As described above, the NE was utilized to emphasize the existence of the SE analytically, where users should react to the utility company's strategy at the same time. However, in practice, it is not appropriate for users to respond to the utility company simultaneously, as they may neutralize each other's impact on the aggregated demands Instead, in the present disclosure, an iterative DR algorithm is designed for reaching the SE in an asynchronous manner, i.e., supposing no two users adjust their power demands at the same time on receipt of the utility company's prices and, more importantly, information exchange between the utility company and a user is executed by hiding private information (e.g., user preference parameter ω_{n,t}).

### Algorithm 1: An Iterative Algorithm for SE

1. The utility company arbitrarily initializes g⁰=[g₁⁰, g₂⁰, . . . , g_{T}⁰] and calculates the initial p⁰=[p₁⁰, p₂⁰, . . . , p_{T}⁰] according to equation (3), assuming that g*=g⁰.

2. The utility company sends p⁰ to all the users, and each user updates its demand vector l*ₙ according to equation

$${l}_{n}^{*} = {arg}_{{l}_{n}} max \{ {U}_{n} ( g , {l}_{n} , {l}_{- n} ) s . t . {l}_{n , t}^{-} \leq {l}_{n , t} \leq {l}_{n , t}^{+} \} .$$

3. Each user n sends l*ₙ back to the utility company and start iteration with index k for convergence to SE.

4. Upon receiving l*ₙ from each user, the utility company updates g*^{,k} by solving the following equations:

g*^{,k}=arg minU_{UC}(g^{k},L^{k})=Σ_{t∈T}(gₜ−g̅)²

s.t.L*ₜ≦gₜ^{k}≦min(gₜ⁺,Lₜ^{max}) where L*ₜ=Σ_{n∈N}l*_{n,t}

5. Based on g*^{,k}, the utility company updates pk according to equation (3) and triggers iteration k: Sequential polling of one user at each time.

6. Sequentially select a user n to send pk at each time.

7. Upon receiving p^{k}, user n updates l*ₙ^{,k} according to the following equation:

$${l}_{n}^{* , k} = {arg}_{{l}_{n}} max \{ {U}_{n} ( g , {l}_{n} , {l}_{- n} ) s . t . {l}_{n , t}^{-} \leq {l}_{n , t} \leq {l}_{n , t}^{+} \}$$

8. User n sends l*ₙ^{,k} back to the utility company in case l*ₙ^{,k} is updated, and then the utility company updates g*^{,k} by solving the following equation:

g*^{,k}=arg minU_{UC}(g^{k},L^{k})=Σ_{t∈T}(gₜ^{k}−g̅^{k})²s.t.L*ₜ≦gₜ^{k}≦min(gₜ⁺,Lₜ^{max})

where

$${L}_{t}^{*} = {\sum }_{{m = 1}_{m \neq n}}^{N - 1} {l}_{m , t}^{*} + {l}_{n , t}^{* , k}$$

9. The utility company calculates new p^{k} accordingly and polls next user.
If the polling is not finished, go to line 6;
else
The utility company evaluates the SE and triggers the next iteration k+1 (go to line 5) in case the SE has not arrived;
end if

10. Repeat lines 5 to 9 until no player deviates from the current strategy, indicating the SE has arrived.

11. The utility company announces to the users that the SE has arrived.

Algorithm 1 begins with the utility company arbitrarily initializing the generation vector g⁰=[g₁⁰, g₂⁰, . . . g_{T}⁰], and calculating the initial price vector p⁰=[p₁⁰, p₂⁰, . . . , p_{T}⁰] accordingly. It is noted that the initial power generation vector g⁰ is regarded as the optimal power generation vector g* temporarily (line 1).

During the initialization, the utility company broadcasts the initial price vector p⁰ to all the users through the two-way communication link, upon which each user will update its demand vector l*ₙ by solving its optimization problem of equation (8). Afterwards, each user sends its demand vector l*ₙ; back to the utility company (lines 2 to 3).

Upon receiving the demand vector l*ₙ in from each user, the utility company updates its power generation vector g*^{,k} (k denotes the index of iterations), by solving its optimization problem of equation (4), wherein Lₜ is updated based on the newly received demand vector l*ₙ from users (line 4).

Based on the power generation vector g*^{,k} obtained in line 4, the utility company updates the price vector p^{k}. Next, the utility company triggers the kth iteration to interact with users, i.e., the utility company polls each user during iteration k (line 5).

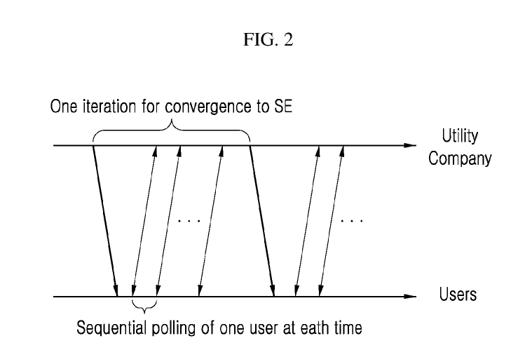

FIG. 2 depicts the interactions between the utility company and users during one iteration, where the utility company sequentially selects one non-repetitive user (e.g., user n) to send the price vector p^{k} at each time (line 6). Upon receiving the price vector p^{k}, user n updates the demand vector l*ₙ^{,k} by solving equation (8) (line 7).

Next, user n sends the demand vector l*ₙ^{,k} back to the utility company, and the utility company updates the generation vector g*^{,k} (by solving equation (4)) (line 8). Here, it is noted that the lower constraint is updated to

$${L}_{t}^{*} = {\sum }_{{m - 1}_{m \neq n}}^{N - 1} {l}_{m , t}^{*} + {l}_{n , t}^{* , k} ,$$

wherein only l*_{n,t}^{k} is newly received from user n, and all other N−1 users' hourly aggregated loads remain the same as when interacting with the last user.

The utility company calculates the new price vector p^{k} according to the updated generation vector g*^{,k} obtained in line 8, and goes to line 6 to poll the next user. In the case where all users have been polled, the utility company evaluates the SE for the kth iteration, and triggers the next iteration k+1 if the SE has not been obtained (line 9). The algorithm then goes to line 5.

In this way, line 5 to line 9 are repeated until the SE is obtained, where the utility company cannot further reduce the generation variation by updating the generation vector, indicating that it has obtained its secured utility value (line 10). Accordingly, the utility company announces to the users that the SE has arrived and each user chooses an optimal strategy obtained by playing with the utility company (line 11).

In the proposed algorithm 1 described above, the utility company selects users in an asynchronous fashion, i.e., no two users update their strategies simultaneously. This can be realized by supposing that the utility company can determine a time when each user should update its strategy. It is noted that each time when new price information is received from the utility company, a user will respond by reducing demand during high-price periods, while increasing demand during low-price periods, resulting in flattened demands Such “flattened demands” sent from the user to the utility company will naturally contribute to the lowering of the generation variance from the perspective of the utility company, because the constraint as represented by equation (4b) described above couples users' aggregated demands with generation, and the utility company will adjust power generation to meet users' flattened demands Furthermore, as the objective of the utility company is to minimize the generation variance (equivalent to acquiring flattened generation) through a number of iterations, the generation variance will gradually decrease and the algorithm will eventually converge to a fixed point, i.e., either to zero or a lower bound of variance.

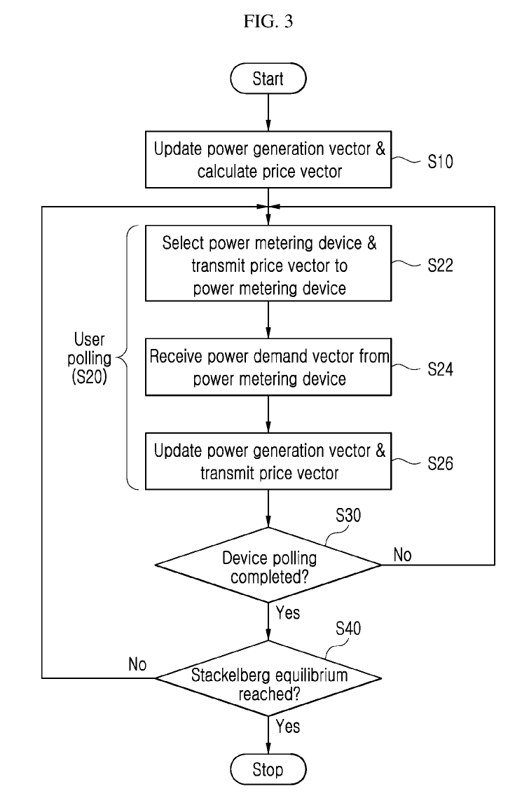

Referring to FIG. 3, descriptions will be made on the process performed at the utility company according to the present disclosure.

When the game starts, the power management apparatus 10 of the utility company transmits an initial price vector (p⁰) to plural power metering devices 20, and updates an initial power generation vector (g⁰) based on a power demand vector (l*^{,k}) received from the plural power metering devices 20. The power management apparatus 10 then calculates a price vector out of the updated initial power generation vector (g⁰). (S10)

The power management apparatus 10, after calculating the price vector by updating the initial power generation vector, enters into a user polling process. (S20) The user polling process is a process in which the power management apparatus 10 sequentially selects plural power metering devices 20 (e.g., N users) to transmit the price vector and updates the power generation vector by sequentially receiving the power demand vector from the plural power metering devices 20

In the user polling process described above, the power management apparatus 10 selects one of the plural power metering devices 20 and transmits the price vector calculated from the updated power generation vector to the selected power metering device 20. (S22)

Subsequently, the power management apparatus 10 receives an updated power demand vector from the selected power metering device 20 (S24), and updates a current power generation vector based on the aggregated power demand vector including the updated power demand vector (S26).

The power management apparatus 10 confirms whether the polling is completed for all of the power metering devices 20 (S30), and when it is determined that the polling is not completed for all of the power metering device 20, repeats the user polling process of S20. When it is determined that the polling is completed for all of the power metering devices 20, the power management apparatus 10 evaluates whether a Stackelberg equilibrium is reached between the leader (utility company) and the followers (N users). (S40)

When it is determined that the Stackelberg equilibrium is not reached, the power management apparatus 10 repeats the user polling process of S20.

When it is determined that the Stackelberg equilibrium is reached, the power management apparatus 10 terminates the game-based supply-demand balance algorithm and notifies the plural power metering devices 20 of the equilibrium state. Subsequently, the power management apparatus 10 generates power according to the power generation vector of an equilibrium state (i.e., the power generation vector updated most recently), and the plural users 20 consume power according to the power demand vector of the equilibrium state (i.e., the power demand vector updated most recently).

### Numerical Analysis

Descriptions will now be made on the numerical analyses assessing the performance of the proposed system and method.

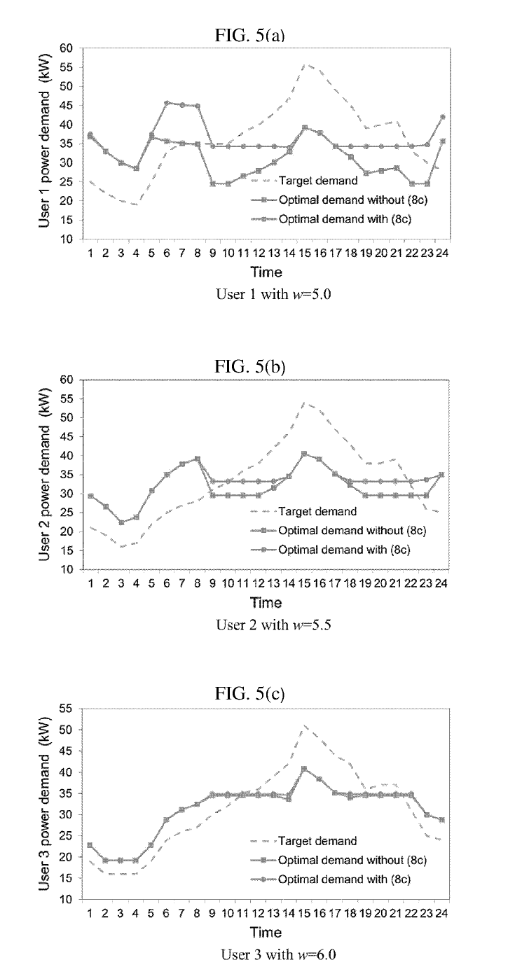

For the convenience of illustration, simulations have been conducted based on a single utility company and three users. For the generation cost, the cost of the same load can be different at different times of day. In particular, the cost may be less at night compared to the day time. For simplicity, the parameters in equation (1) are set to aₜ=0.02 during daytime (i.e., from 8:00 to 24:00) and aₜ=0.01 in the remaining hours, bₜ=0.2 and cₜ=0, and the price coefficient λₜ was selected to be 1.2. For the user utility function, the parameter θₙ was selected as 0.1 for all users, and ω_{n,t} was set to different values of 5.0, 5.5, and 6.0. The effect of these differing values will be discussed later in the simulation results. The target power demand of user 1, 2 and 3 is shown as a dotted line in FIG. 5(a), 5(b), 5(c) respectively, where the target power demand is defined as the power demand of a user without the adoption of demand response management. In the present disclosure, the target power demands have been obtained from an existing electric power market, which provided daily loads for certain local regions. However, the order of magnitude has been changed from GW to kW to account for the limited number of users in the sample experiment. The minimum and maximum of each user's demands are set to certain percentages of the target demands, as given in Table 1 described below. For simplicity, the maximum generation capacity was assumed to be equal to the maximum total power demands of all the users. As a result, a relationship gₜ⁺=Σ_{n∈N} l_{n,t}⁺ has been obtained for all t∈T. In the case whereby the temporally-coupled constraint in (8c) is included, it is supposed that a user would like to consume a fixed amount of power equal to the sum of the target demands.

TABLE 1
User Power Demand Ranges

| | User 1 | User 2 | User 3 |
|---|---|---|---|
| | (%) | (%) | (%) |
| Min demand | 70 | 75 | 80 |
| Max demand | 150 | 140 | 120 |

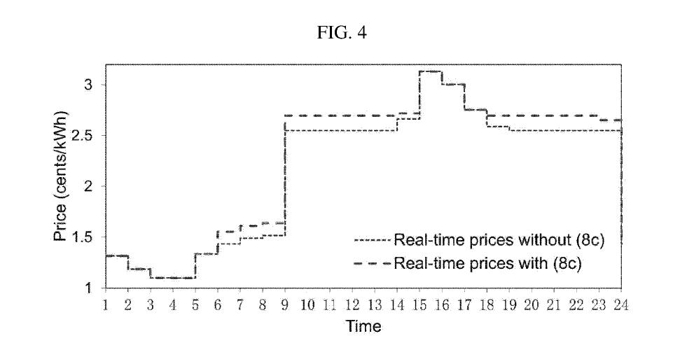

FIG. 4 shows the real-time prices obtained from Algorithm 1 by distinguishing two cases, i.e., with and without the temporally coupled constraint represented as equation (8c). In the following, the performance will be analyzed with various scenarios.

### Scenario 1: Optimal Power Demands of Users

FIGS. 5(a), 5(b) and 5(c) each illustrate each user's power demands with and without constraint represented as equation (8c) as shown by the dot-connected line ( [symbol] ) and square-connected line ( [symbol] ), (respectively, and also in comparison to each user's target demands. In general, for either case (with or without constraint represented as equation (8c)), a user demanded more power than the target amount during off-peak times, and curtailed their demand during peak times, indicating a large amount of demand was shifted from on-peak to off-peak slots.

Specifically, when the constraint represented as equation (8c) was not applied, by comparing users' power demand results in FIGS. 5(a), 5(b) and 5(c), it can be observed that user 1 (ω_{n,t}=5.0) would be more willing to participate in the demand response process, as it reduced larger amounts of demand during the high price period compared with the other two users. This phenomenon coincides with the physical meaning of ω_{n,t} described above (i.e., a user with a greater ω_{n,t} preferred to consume more l_{n,t} in order to reach a higher satisfaction level and vice versa).

In the case where the constraint represented as equation (8c) was applied, it has been found out that each user demanded more power than without that constraint in order to complete the target daily consumption, whereas the extra demands were increased during lower price slots.

### Scenario 2: Comparison of Supply and Demand

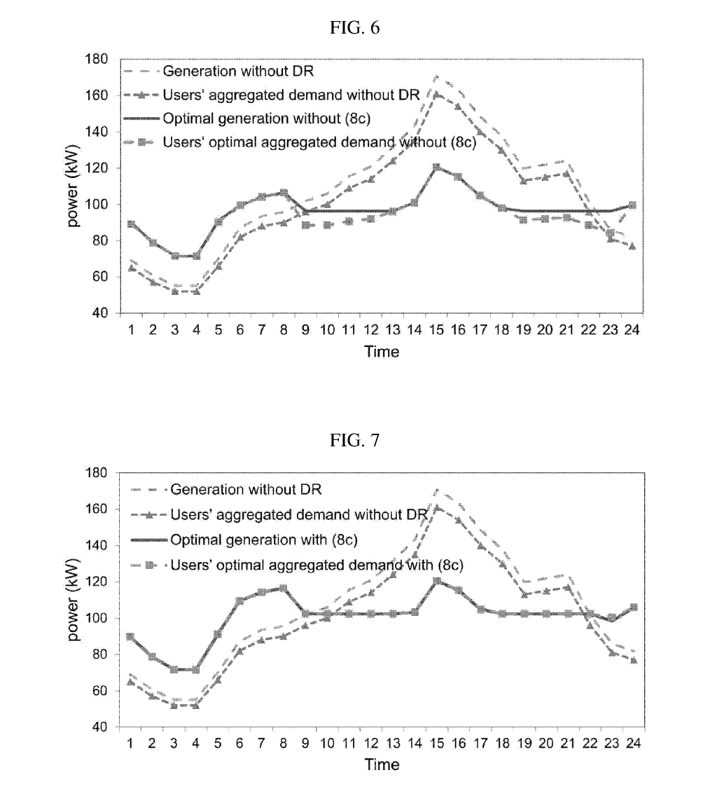

FIGS. 6 and 7 each illustrate the resulting hourly power generation (supply) together with users' hourly aggregated demands compared to the case when there was no demand response scheme applied (i.e., supposing hourly generation was chosen at the median between the minimum aggregated demands of all users (Σ_{n∈N} l_{n,t}⁻) and the maximum generation capacity (gₜ⁺), while each user demanded the target power amount regardless of energy cost. Thus, in FIGS. 6 and 7, “users' aggregated demands without DR” are the sum of each user's target demands as illustrated in FIG. 5.

When no demand response was applied, there existed a large gap between supply and demand. In the case where the demand response scheme was applied (without constraint of (8c) and with constraint (8c)), it efficiently reshaped the generation and users' demands including reducing the peak demand and filling the vacancy of valley demands. As shown in FIGS. 6 and 7, the gap between supply and demand was reduced significantly. Moreover, without the constraint represented as equation (8c), the mismatch may not be eliminated completely as illustrated in FIG. 6. For comparison, the generation in FIG. 7 matched well with users' demands when the constraint represented as equation (8c) was implemented. The numerical analyses of the supply-demand mismatch will be discussed hereinbelow.

### Scenario 3: Performance Evaluation.

The performance of three cases have been evaluated from various aspects: Case 1. No DR; Case 2. DR without constraint of (8c); and Case 3. DR with constraint of (8c). The numerical comparison results are listed in Table 2 below. The load factor (LF) is defined as the average to peak load ratio (see equation (5)), which is expected to be as large as possible.

TABLE 2
Performance evaluation.

| | | | | Generation amount | | | |
|---|---|---|---|---|---|---|---|
| | Peak demand | Total demand | | (per 24 h) | Generation cost | Generation | Total payments |
| Cases | (kW h) | (kW h) | LF | (kW h) | ($) | variance | ($) |
| Case 1: No DR | 161 | 2414 | 0.625 | 2560 | 32.3 | 1080 | 76.4 |
| Case 2: DR Without | 121 | 2254 | 0.775 | 2314 | 23.5 | 141 | 49.3 |
| (8c) | | | | | | | |
| Case 3: DR With (8c) | 121 | 2414 | 0.833 | 2416 | 25.4 | 175 | 55.1 |

From Table 2, it is observed that the peak demand apparently decreased from 161 kW h (per hour) to 121 kW h (per hour) with the help of the demand response scheme. As the constraint represented as equation (8c) was not considered in Case 2, total demand is reduced by 160 kW h (per 24 h) compared to Case 1 and Case 3. However, Case 3 was able to achieve the lowest PAR and highest LF, which are advantageous for the utility company in balancing loads in the power system. When comparing the generation amount and the total demand, it is clear that supply and demand were generally matched under the demand response scheme but that a large gap exists in Case 1, which can be seen in FIGS. 6 and 7. Specifically, the power supply and demand were matched appropriately in Case 3.

In addition, both generation costs and user payments were much lower in Case 2 and Case 3 than in Case 1, and Case 2 reduced payments more than Case 3. However, this was achieved at the expense of missing the users' target demands, meaning that some daily tasks may not be completed. Also, it can be seen that the generation variance in Case 2 and Case 3 (in order to meet users' target demands, Case 3 resulted in slightly higher variance than Case 2) was significantly reduced compared with Case 1, which is desirable for the utility company to maintain the stability of the power grid.

### Scenario 4: Scalability

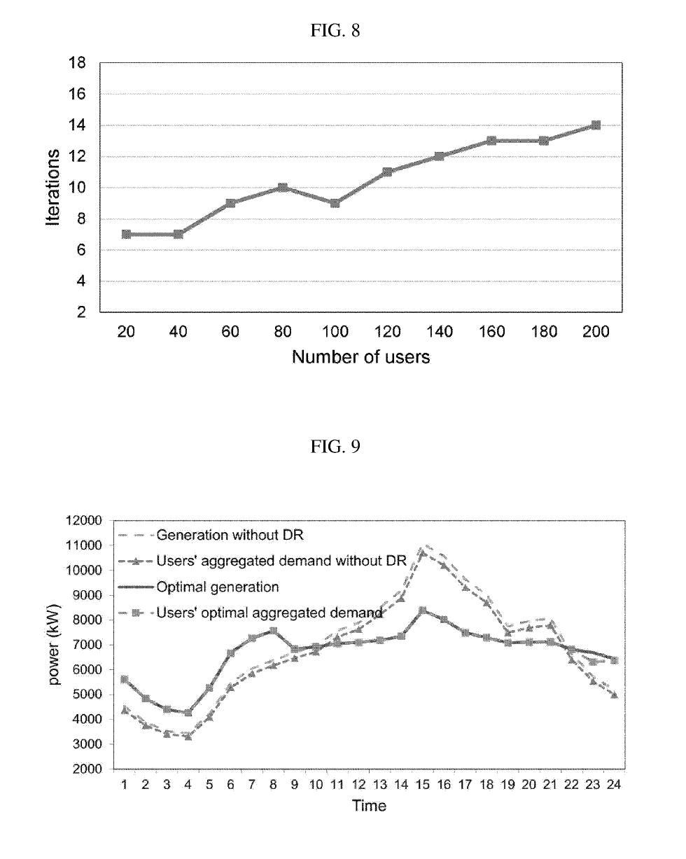

For the three users above, the algorithm took seven iterations to converge to the SE. In order to examine the scalability of the algorithm, the user number has been increased from 20 to 200, wherein ω_{n,t} were randomly selected between [5.0, 6.0], and users' target hourly demands were randomly set from 14 kWh to 56 kWh (i.e., the min and max target demand of the three example users). FIG. 8 illustrates the number of iterations needed with increasing user number, and illustrates a linear rather than exponential increase in iterations, which is desirable for the proposed algorithm to be practically implemented in a smart grid application.

In order to get insight into the effectiveness of the proposed DR algorithm in presence of considerable number of users, the resulted optimal supply and aggregated demand have been presented under the extreme case of 200 users. As illustrated in FIG. 9, by deploying the algorithm, the generation and users' aggregated demand are rescheduled and matched generally, resulting in smoothed overall loads in the system. Specifically, the load factor was increased from 0.62 (without DR) to 0.8 (with DR), indicating that the presented algorithm works well in handling the power management problem between one utility and multiple users.

A Stackelberg game based demand response model between one utility company and multiple users has been described, aimed at balancing the power supply and demand as well as flattening the aggregated load in the system. The game formulation process has been described in detail together with an analysis of the existence of the Stackelberg equilibrium. An iterative algorithm between the utility company and plural users has been proposed to derive the Stackelberg equilibrium, which provides the optimal power generation and demand for the utility company and plural users. The numerical results show that the proposed method and system can help flatten aggregated loads in the system and significantly reduce the mismatch between the power supply and demand As an extension of the current disclosure, intermittent power resources such as photovoltaic cells and wind turbines may be taken into account, so as to make the existing model accommodate dynamic ambient changes for the power generation devices. Also, it is noted that the proposed algorithm may be evaluated in a distribution network with nodal pricing approaches and power flow analyses.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has (have) been described in detail, it should be understood that the various changes, substitutions, and alterations could be made hereto without departing from the spirit and scope of the invention.

What is claimed is:

1. A supply-demand balancing method for power management in a smart grid, the power supply-demand balancing method comprising:
transmitting an initial price vector (p⁰) calculated from an initial power generation vector (g⁰) from a power management apparatus to a plurality of power metering devices;
transmitting a power demand vector (l₁*, l₂*, . . . , l_{N}*) calculated based on the initial price vector (p⁰) from each of the plurality of power metering devices to the power management apparatus;
transmitting a first price vector (p^{k}), which is calculated based on a first power generation vector (g*^{,k}) which in turn is calculated based on the power demand vector (l₁*, l₂*, . . . , l_{N}*), from the power management apparatus to a first power metering device selected from the plurality of power metering devices; and
transmitting a first power demand vector (l₁*^{,k}), which is calculated based on the first price vector (p^{k}), from the first power metering device to the power management apparatus.

2. The supply-demand balancing method according to claim 1 further comprising:
calculating a second power generation vector (g*^{,k}) based on the power demand vector (l₁*^{,k}, l₂*, . . . , l_{N}*) including the first power demand vector (l₁*^{,k}), and calculating a second price vector (p^{k}) based on the second power generation vector (g*^{,k}), by the power management apparatus;
transmitting the second price vector (p^{k}) from the power management apparatus to a second power metering device selected from the plurality of power metering devices; and
transmitting a second power demand vector (l₂*^{,k}), calculated by on the second price vector (p^{k}), from the second power metering device to the power management apparatus.

3. The supply-demand balancing method according to claim 2 further comprising:
repeating the second price vector calculating, the second price vector transmitting, and the second power demand vector transmitting for each of the plurality of power metering devices excluding the first power metering device and the second power metering device; and
determining whether the power generation vector (g*^{,k}) and the power demand vector (l₁*^{,k}, l₂*^{,k}, . . . , l_{N}*^{,k}) calculated by the power management apparatus for the last time reach a Stackelberg equilibrium (SE).

4. A supply-demand balancing method for power management in a smart grid, the power supply-demand balancing method comprising:
a first step of receiving an aggregated power demand vector from a plurality of power metering devices by a power management apparatus, after transmitting an initial price vector calculated from an initial power generation vector to the plurality of power metering devices;
a second step of transmitting a price vector calculated from a power generation vector updated based on the aggregated power demand vector to a power metering device selected from the plurality of power metering devices by the power management apparatus;
a third step of transmitting a power demand vector updated based on the price vector to the power management apparatus by the selected power metering device;
a fourth step of transmitting the price vector calculated from the generation vector updated based on the aggregated power demand vector including the updated power demand vector to another power metering device selected from the plurality of power metering device by the power management apparatus;
a fifth step of transmitting the power demand vector updated based on the price vector to the power management apparatus by the selected another power metering device;
a sixth step of repeating the fourth step and the fifth step for all of the plurality of power metering devices excluding the selected power metering device and the selected another power metering device; and
a seventh step of determining whether the power generation vector updated for the last time and the aggregated power demand vector updated by the plurality of power metering devices reach a Stackelberg equilibrium (SE) by the power management apparatus.

5. The supply-demand balancing method according to claim 4, wherein when it is determined that the Stackelberg equilibrium is not reached at the seventh step, the method performs the fourth step to sixth step.

6. The supply-demand balancing method according to claim 4, wherein when it is determined that the Stackelberg equilibrium is reached at the seventh step, the power management apparatus generates power according to the power generation vector which is updated most recently, and the plurality of users consume power according to the updated aggregated power demand vector.

7. The supply-demand balancing method according to claim 4, wherein the power generation vector is a set of power generation per unit time of a predetermined period, and the power demand vector is a set of consumed power amount of users per unit time of a predetermined period.

8. The supply-demand balancing method according to claim 5, wherein the aggregated power demand vector is a set that gathered the power demand vector of each of the plurality of users.

9. A supply-demand balancing method for power management in a smart grid, the method comprising:
sequentially performing, by a power management apparatus, updating a power generation vector based on a power demand vector, calculating a price vector from the updated generation vector, transmitting the calculated price vector to a power metering device selected from a plurality of power metering device, and receiving a power demand vector from the selected power metering device, for all of the plurality of users.

10. The supply-demand balancing method according to claim 9, wherein when the updating, calculating, transmitting and receiving are completed for all of the plurality of power metering devices, the power management apparatus determines whether the power generation vector which has been updated most recently and an aggregated power demand vector of the plurality of users reach a Stackelberg equilibrium (SE).

11. The supply-demand balancing method according to claim 10, wherein when the Stackelberg equilibrium is not reached, the power management apparatus sequentially performs the updating, calculating, transmitting and receiving for each of the plurality of power metering devices.

12. The supply-demand balancing method according to claim 10, wherein when the Stackelberg equilibrium is reached, the power management apparatus generates power according to the power generation vector which has been updated most recently.

13. A supply-demand balancing system for power management in a smart grid, the system comprising:
a power management apparatus provided in a utility company generating power; and
a plurality of power metering devices each in communication with the power management apparatus,
wherein the power management apparatus is configured to update a power generation vector of the utility company, calculate a price vector based on the updated generation vector, select one of the plurality of power metering devices, and transmit the calculated price vector to the selected power metering device, and
each of the power metering device is configured to update a power demand vector of its own based on the price vector received from the power management apparatus.

14. The supply-demand balancing system according to claim 13, wherein when the power management apparatus initially selects one of the plurality of power metering devices, the power management apparatus updates the power generation vector based on an aggregated power demand vector which has been updated by the plurality of power metering devices based on an intial price vector.

15. The supply-demand balancing system according to claim 13, wherein when the power management apparatus makes a selection for the plurality of power metering devices 2 or more times, the power management apparatus updates the power generation vector according to an aggregated power demand vector including the power demand vector which has been updated based on the price vector by a previously selected power metering device.

16. A supply-demand balancing system for power management in a smart grid, the system comprising:
a power management apparatus provided in a utility company generating power; and
a plurality of power metering devices each in communication with the power management apparatus,
wherein the power management apparatus is configured to update a power generation vector of the utility company, and transmitting a price vector calculated from the updated generation vector;
each of the plurality of power metering devices is configured to return a power demand vector updated based on the price vector; and
the power generation vector and the power demand vector are exchanged between the power management apparatus and the plurality of power metering devices until a Stackelberg equilibrium (SE) is reached.

17. The supply-demand balancing system according to claim 16, wherein the power management apparatus updates the power generation vector based on the updated power demand vector such that a variation rate of power generation becomes minimized in the utility company.

18. The supply-demand balancing system according to claim 16, wherein each of the plurality of power metering devices updates the power demand vector based on the price vector such that a value obtained by subtracting a paid cost from a satisfied gain becomes maximized.

19. A power management apparatus of a utility company supplying power to a plurality of users,
wherein the power management apparatus updates a power generation vector according to a power demand vector received from a plurality of users by selecting the power generation vector from a strategic set of the utility company such that a utility function, which is represented as a sum of an average generation amount of a predetermined period and a squared value of a difference of a generation amount between specific time periods, becomes minimized.

20. A power metering device to which power is supplied from a utility company,
wherein, when a price vector is received from the utility company, the power metering device is configured to update a power demand vector according to the price vector by selecting the power demand vector from a strategic set of the power metering device such that a utility function, which is represented as a difference between a satisfied gain and a paid cost, becomes maximized.
